(19) United States
(12) Patent Application Publication
(10) Pub. No.: US 2025/0012563 A1
(43) Pub. Date: Jan. 9, 2025

(54) SURFACE SHAPE MEASUREMENT DEVICE AND SURFACE SHAPE MEASUREMENT METHOD

(71) Applicant: Tokyo Seimitsu Co., Ltd., Tokyo (JP)

(72) Inventor: Kyohei HAYASHI, Tsuchiura-city (JP)

(73) Assignee: Tokyo Seimitsu Co., Ltd., Tokyo (JP)

(21) Appl. No.: 18/894,717

(22) Filed: Sep. 24, 2024

Related U.S. Application Data
(63) Continuation of application No. PCT/JP2023/010045, filed on Mar. 15, 2023.

(30) Foreign Application Priority Data
Mar. 25, 2022 (JP) 2022-050562

(51) Int. Cl. G01B 11/24

(52) U.S. Cl. CPC G01B 11/24

(57) ABSTRACT

A surface shape measurement device includes: a first image capturing system configured to capture a first captured image of a measurement object while scanning relative to the measurement object; a second image capturing system that is separate from the first image capturing system and configured to capture a second captured image of the measurement object or a support body thereof in synchronization with the first image capturing system; a calculating unit configured to calculate a surface shape of the measurement object based on first captured images; a storage unit configured to store coordinate system transformation information for transforming a second coordinate system to a first coordinate system; a displacement detecting unit configured to detect displacement of the measurement object based on second captured images; and a correcting unit configured to correct the surface shape based on a detection result of the displacement and on the coordinate system transformation information.

### CROSS-REFERENCE TO RELATED APPLICATIONS

The present application is a Continuation of PCT International Application No. PCT/JP2023/010045 filed on Mar. 15, 2023 claiming priority under 35 U.S.C § 119 (a) to Japanese Patent Application No. 2022-050562 filed on Mar. 25, 2022. Each of the above applications is hereby expressly incorporated by reference, in their entirety, into the present application.

### BACKGROUND OF THE INVENTION

### Field of the Invention

The presently disclosed subject matter relates to a surface shape measurement device and a surface shape measurement method.

### Description of the Related Art

There has been known a scanning measurement method of using scanning measurement devices, such as microscopes employing a focus variation (FV) scheme, microscopes employing a confocal scheme, a white interference microscopes and auto focus (AF) devices, to measure a three-dimensional shape (such as an all-in-focus image and a surface shape) of a surface to be measured of a measurement object (see PTL 1 to 3). Such measurement devices cause a microscope provided with a camera to scan in a scanning direction and capture an image of the surface to be measured at a fixed pitch by the camera, and calculate, based on the captured image for each pitch, sharpness (focus position of the microscope) for each pixel of the respective captured images or calculate height information for each pixel to measure the three-dimensional shape of the surface to be measured. These measurement devices can acquire a height profile of the measurement object in plane, which makes the measurement devices very useful at the time of measuring fine three-dimensional shapes and roughness.

### CITATION LIST

### Patent Literature

PTL 1: Japanese Patent Application Laid-Open No. 2016-99213
PTL 2: Japanese Patent Application Laid-Open No. 2015-84056
PTL 3: Japanese Patent Application Laid-Open No. 2016-90520

### SUMMARY OF THE INVENTION

Incidentally, a problem with the above-mentioned measurement devices, which need to cause the optical system to scan in a height direction, is that when positional deviation of the measurement object or vibration occurs during scanning, the positional deviation tends to be noticeable as a measurement error.

To cope with the problem, it may be conceivable to install the measurement devices on a vibration isolation table to block vibration from the floor or install a wind proof cover around the measurement devices to block vibration caused by wind or sound.

However, there are problems that installation of the vibration isolation tables and wind proof/sound proof covers has significant spatial constraints and it is not possible to install the vibration isolation tables or the wind proof/sound proof covers particularly on the measurement devices within a processing machine or in a factory line.

An object of the presently disclosed subject matter, which has been made in view of such circumstances, is to provide a surface shape measurement device and a surface shape measurement method capable of reducing an error due to influence of vibration generated during measurement.

A surface shape measurement device configured to measure a surface shape of a measurement object of a first aspect includes: a first image capturing system configured to capture an image of the measurement object at each prescribed imaging interval while scanning in a vertical direction relative to the measurement object; a second image capturing system that is separate from the first image capturing system and is configured to capture an image of the measurement object or a support body for the measurement object in synchronization with the first image capturing system; a calculating unit configured to calculate the surface shape of the measurement object based on a plurality of first captured images captured by the first image capturing system; a storage unit configured to store coordinate system transformation information for transforming a second coordinate system of the second image capturing system to a first coordinate system of the first image capturing system; a displacement detecting unit configured to detect displacement of the measurement object during image capturing by the first image capturing system based on a plurality of second captured images captured by the second image capturing system; and a correcting unit configured to correct the surface shape calculated by the calculating unit based on a detection result of the displacement detecting unit and on the coordinate system transformation information.

In the surface shape measurement device of a second aspect, the coordinate system transformation information is a transformation matrix that transforms the second coordinate system to the first coordinate system.

The surface shape measurement device of a third aspect includes a calibrating unit configured to acquire the coordinate system transformation information from a result of image capturing on a calibration target by the first image capturing system and the second image capturing system.

In the surface shape measurement device of a fourth aspect, the second image capturing system includes a monocular camera, and the displacement detecting unit detects the displacement of the measurement object by a bundle adjustment scheme.

In the surface shape measurement device of a fifth aspect, the second image capturing system includes a compound-eye camera, and the displacement detecting unit detects the displacement of the measurement object by a stereo camera scheme.

In the surface shape measurement device of a sixth aspect, when a marker is attached to the measurement object or the support body for the measurement object, the displacement detecting unit tracks the marker to detect the displacement of the measurement object.

In the surface shape measurement device of a seventh aspect, when a marker is not attached to the measurement object or the support body for the measurement object, the displacement detecting unit tracks a feature point set for the measurement object or the support body for the measurement object to detect the displacement of the measurement object.

In the surface shape measurement device of an eighth aspect, the first image capturing system is a microscope employing any one of a white interference scheme, a laser confocal scheme, and a focal point scheme.

A surface shape measurement method of a ninth aspect includes: a first image capturing step of capturing an image of a measurement object at each prescribed imaging interval while causing a first image capturing system to scan in a vertical direction relative to the measurement object; a second image capturing step of using a second image capturing system that is separate from the first image capturing system to capture an image of the measurement object or a support body for the measurement object in synchronization with the first image capturing system; a calculating step of calculating a surface shape of the measurement object based on a plurality of first captured images captured in the first image capturing step; a displacement detecting step of detecting displacement of the measurement object during image capturing by the first image capturing system based on a plurality of second captured images captured by the second image capturing system; and a correcting step of correcting the surface shape calculated in the calculating step based on a detection result of the displacement detecting step and on coordinate system transformation information for transforming a second coordinate system of the second image capturing system to a first coordinate system of the first image capturing system.

The presently disclosed subject matter can reduce an error due to influence of vibration generated during measurement.

### BRIEF DESCRIPTION OF THE DRAWINGS

FIG. 1 is a schematic view of a surface shape measurement device of a first embodiment;

FIG. 2 is an explanatory view for describing a first image capturing system;

FIG. 3 is an explanatory view for describing a second image capturing system;

FIG. 4 is a functional block diagram of a control device for the surface shape measurement device of the first embodiment;

FIG. 5 is an explanatory view for describing optical flow;

FIG. 6 is an explanatory view for describing a marker;

FIG. 7 is a flowchart indicating an example of a surface shape measurement method;

FIG. 8 is an explanatory view for describing calibration as an advance preparation; and

FIG. 9 is a schematic view of a surface shape measurement device of a second embodiment.

### DESCRIPTION OF THE EMBODIMENTS

Hereinafter, preferred embodiments of the presently disclosed subject matter are described based on the accompanying drawings.

### First Embodiment

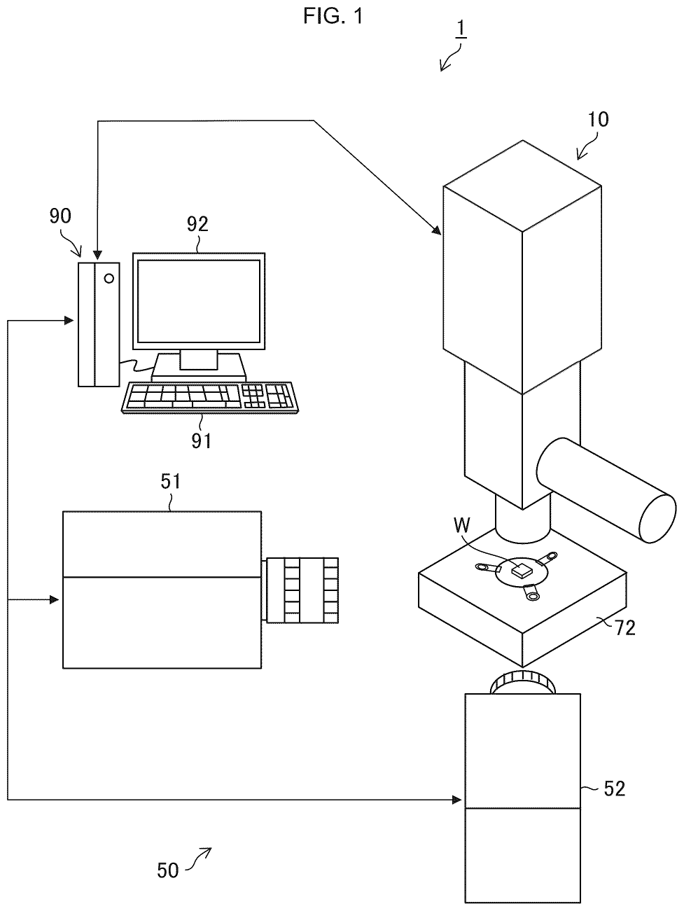

FIG. 1 is a schematic view of a surface shape measurement device 1 of a first embodiment. In the XYZ directions orthogonal to each other in the drawing, the XY directions are horizontal directions, and the Z direction is an up-down direction (vertical direction).

As illustrated in FIG. 1, the surface shape measurement device 1, which is a measurement device that measures a surface shape of a measurement object W, includes a first image capturing system 10, a second image capturing system 50 that is separate from the first image capturing system 10, and a control device 90. In FIG. 1, the measurement object W is mounted on a jig 72. The jig 72 is an example of a support body for the measurement object W of the presently disclosed subject matter. As long as the support body for the measurement object W can support the measurement object W, the size, shape, or the like of the support body is not limited.

The first image capturing system 10 captures an image of the measurement object W at each prescribed imaging interval while scanning in a vertical direction relative to the measurement object W. The first image capturing system 10 is a microscope employing a white interference scheme in the embodiment.

The second image capturing system 50 captures an image of the measurement object W or the jig 72 in synchronization with the first image capturing system 10. In the first embodiment, the second image capturing system 50 includes two cameras 51 and 52 and is configured as a stereo camera (compound-eye camera).

The control device 90 is connected to the first image capturing system 10 and the second image capturing system 50 to comprehensively control the surface shape measurement device 1 in accordance with input operation to an operating unit 91. A display unit 92 displays various kind of information under control of the control device 90.

In the surface shape measurement device 1 of the first embodiment, the first image capturing system 10 captures an image of the measurement object W, while the second image capturing system 50 that is separate from the first image capturing system 10 captures an image of displacement of the measurement object W from the start of image capturing by the first image capturing system 10. The surface shape measurement device 1 calculates the surface shape of the measurement object W based on captured images (first captured images of the presently disclosed subject matter) captured by the first image capturing system 10. The surface shape measurement device 1 further corrects the surface shape of the measurement object W calculated as described above, based on the displacement (translation displacement and rotation displacement) detected based on captured images (second captured images of the presently disclosed subject matter) captured by the second image capturing system 50.

Here, in the surface shape measurement device 1, calibration is performed to acquire coordinate system transformation information (coordinate system transformation matrix for transforming a second coordinate system of the second image capturing system 50 to a first coordinate system of the first image capturing system 10) as an advance preparation for measurement, and the coordinate system transformation information acquired by calibration is stored in a storage unit 108, which will be described later. At the time of measuring the measurement object W, the surface shape measurement device 1 corrects the surface shape of the measurement object W based on the results of image capturing, which are images of the measurement object W captured by the first image capturing system 10 and the second image capturing system 50, and on the coordinate system transformation information stored in the storage unit 108. The calibration of the surface shape measurement device 1 is described later.

Since the surface shape measurement device 1 is calibrated in advance, it is preferable that the relative positions of the first image capturing system 10 and the second image capturing system 50 at the time of measurement are the same as those at the time of calibration. Therefore, the first image capturing system 10 and the second image capturing system 50 are installed in the same system, for example, in the same frame, or the like.

Next, each configuration of the first image capturing system 10, the second image capturing system 50, and the control device 90 is described.

### First Image Capturing System

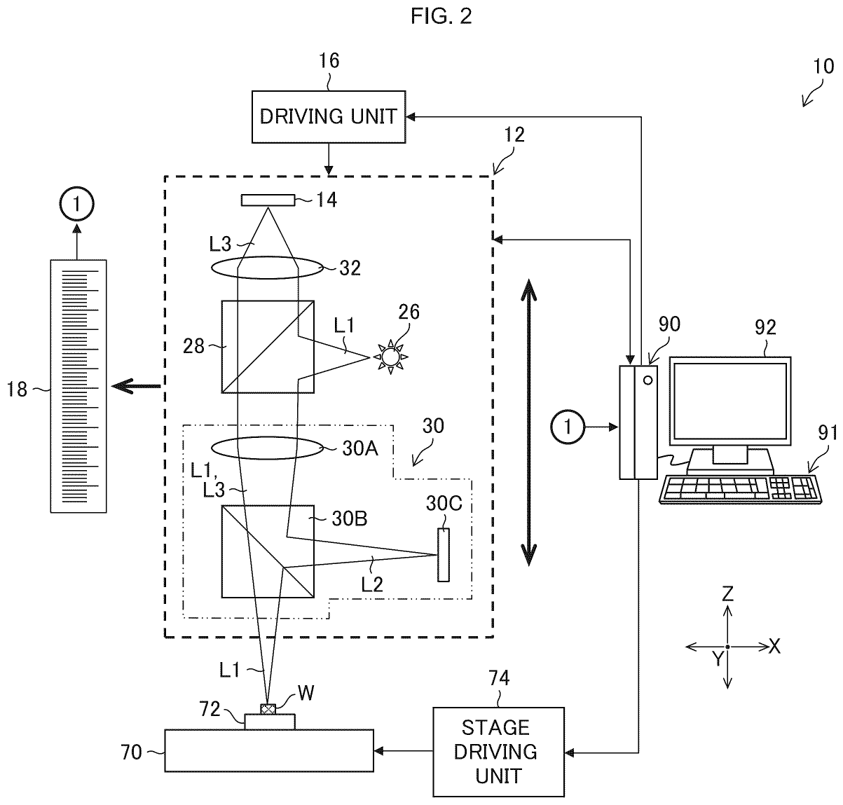

FIG. 2 is an explanatory view for describing the first image capturing system 10. As illustrated in FIG. 2, in order to measure a three-dimensional shape (surface shape) of the surface to be measured of the measurement object W, the first image capturing system 10 includes an optical head 12, a driving unit 16, an encoder 18, a stage 70, and a stage driving unit 74. The stage 70 is arranged below the optical head 12 in the Z direction.

The optical head 12 includes a Michelson-type white interference microscope as illustrated in FIG. 1.

The optical head 12 includes a camera 14, a light source unit 26, a beam splitter 28, an interference objective lens 30, and an imaging lens 32.

The interference objective lens 30, the beam splitter 28, the imaging lens 32, and the camera 14 are arranged in this order along the Z direction upward from the measurement object W. Further, the light source unit 26 is arranged at a position facing the beam splitter 28 in the X direction (or can be the Y direction).

The light source unit 26 emits white light (low-coherence light with low coherence) of a parallel light flux toward the beam splitter 28 as measurement light L1 under control of the control device 90. While not illustrated, the light source unit 26 includes a light source capable of emitting the measurement light L1, such as a light-emitting diode, a semiconductor laser, a halogen lamp and a high-brightness discharge lamp, and a corrector lens that converts the measurement light L1 emitted from the light source into a parallel light flux.

As the beam splitter 28, for example, a half mirror is used. The beam splitter 28 reflects part of the measurement light L1 incident from the light source unit 26 toward the interference objective lens 30 on a lower side in the Z direction. Further, the beam splitter 28 allows part of multiplexed light L3 which is incident from the interference objective lens 30 and which will be described later to pass to the upper side in the Z direction and emits the multiplexed light L3 toward the imaging lens 32.

The interference objective lens 30, which is a Michelson-type lens, includes an objective lens 30A, a beam splitter 30B, and a reference surface 30C. The beam splitter 30B and the objective lens 30A are arranged in this order along the Z direction upward from the measurement object W. Further, the reference surface 30C is arranged at a position facing the beam splitter 30B in the X direction (or can be the Y direction).

The objective lens 30A has a focusing function and causes the measurement light L1 incident from the beam splitter 28 to focus on the measurement object W through the beam splitter 30B.

As the beam splitter 30B, for example, a half mirror is used. The beam splitter 30B splits part of the measurement light L1 incident from the objective lens 30A as reference light L2, allows the remaining measurement light L1 to pass and emits the remaining measurement light L1 to the measurement object W, and emits the reference light L2 to the reference surface 30C. The measurement light L1 that has passed through the beam splitter 30B is radiated on the measurement object W, then reflected by the measurement object W and returns to the beam splitter 30B.

As the reference surface 30C, for example, a reflecting mirror is used, and the reference surface 30C reflects the reference light L2 incident from the beam splitter 30B toward the beam splitter 30B. The position of the reference surface 30C in the X direction can be manually adjusted using a position adjustment mechanism (not illustrated). This makes it possible to adjust a light path length of the reference light L2 between the beam splitter 30B and the reference surface 30C. The reference light path length is adjusted to be equal (including roughly equal) to the light path length of the measurement light L1 between the beam splitter 30B and the measurement object W.

The beam splitter 30B generates the multiplexed light L3 of the measurement light L1 returning from the measurement object W and the reference light L2 returning from the reference surface 30C and emits the multiplexed light L3 toward the objective lens 30A on the upper side in the Z direction. The multiplexed light L3 passes through the objective lens 30A and the beam splitter 28 and is incident on the imaging lens 32. In the case of a white interference microscope, the multiplexed light L3 becomes interference light including interference fringes.

The imaging lens 32 forms an image of the multiplexed light L3 incident from the beam splitter 28 on an imaging surface (not illustrated) of the camera 14. Specifically, the imaging lens 32 forms an image of a point on a focal plane of the objective lens 30A as an image point on the imaging surface of the camera 14.

The camera 14 includes a charge coupled device (CCD)-type or a complementary metal oxide semiconductor (CMOS)-type imaging element (not illustrated). While the camera 14 is being caused to scan by the driving unit 16, the camera 14 captures images of the multiplexed light L3 imaged on the imaging surface by the imaging lens 32 as the images of the measurement object W.

The driving unit 16 includes a publicly known linear motor or a motor drive mechanism. The driving unit 16 holds the optical head 12 so as to allow the optical head 12 to scan in the Z direction, which is the vertical scanning direction (optical axis direction of the optical head 12), relative to the measurement object W. The driving unit 16 moves the optical head 12 relative to the measurement object W within the range of a set scanning speed and a set scanning direction under control of the control device 90.

The driving unit 16 only requires to be able to cause the optical head 12 to scan in the scanning direction relative to the measurement object W and, for example, may cause the stage 70, which supports the measurement object W, to scan in the scanning direction.

The stage 70 has a stage surface to support the measurement object W. The stage surface includes a flat surface roughly parallel to the X direction and the Y direction. The stage driving unit 74 includes a publicly known linear motor or a motor drive mechanism, and moves the stage 70 horizontally and relative to the optical head 12 in a plane vertical to the scanning direction (the X and Y directions) under control of the control device 90.

The encoder 18 is a position detection sensor that detects the position of the optical head 12 with respect to the measurement object W in the scanning direction and, for example, an optical linear encoder (also referred to as a scale) is used as the encoder 18. The optical linear encoder includes, for example, a linear scale having slits formed at regular intervals, and a light-receiving element and a light-emitting element arranged so as to face each other across the linear scale.

### Second Image Capturing System

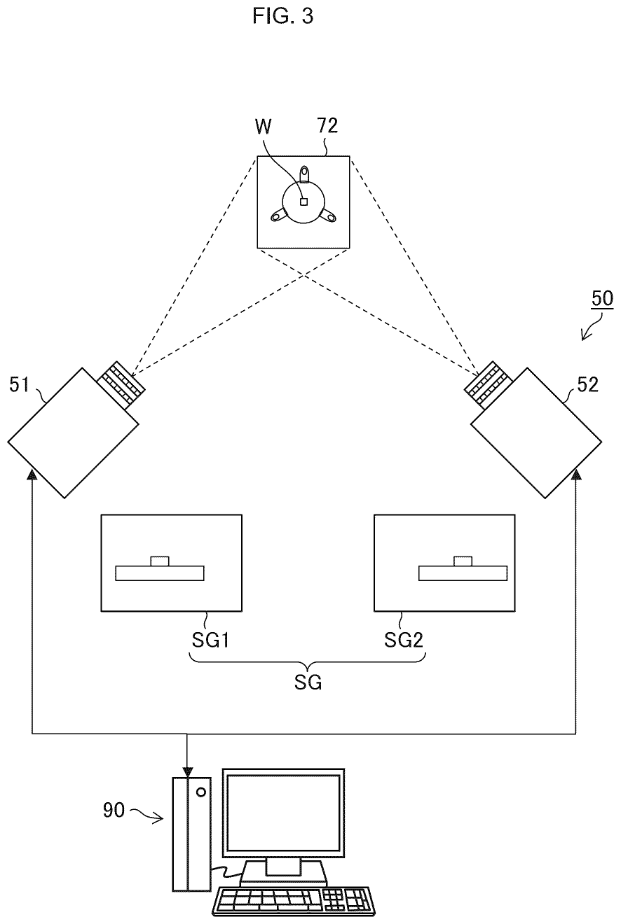

FIG. 3 is an explanatory view for describing the second image capturing system 50. As indicated in FIG. 3, the second image capturing system 50 includes two monocular cameras 51 and 52, which function as a stereo camera. The cameras 51 and 52 each include a CCD-type or CMOS-type imaging element and a lens system. The cameras 51 and 52 of the second image capturing system 50 capture images of the measurement object W or the jig 72 from different directions while the first image capturing system 10 captures images of the measurement object W. The second image capturing system 50 outputs captured stereo images SG as the second captured images to the control device 90. Each of the stereo images SG includes a first stereo image SG1 captured by the camera 51 and a second stereo image SG2 captured by the camera 52. Since the stereo images SG include binocular parallax, processing performed based on the stereo images SG in the control device 90 makes it possible to acquire three-dimensional coordinates in stereoscopic space.

As described before, the first image capturing system 10 includes the camera 14, and the second image capturing system 50 includes the cameras 51 and 52. However, the camera 14 is different in characteristics from the cameras 51 and 52 due to the respective purposes of the first image capturing system 10 and the second image capturing system 50. Since the first image capturing system 10 measures fine shapes and roughness of the measurement object W, the camera 14 requires a high resolution that can discriminate space. On the other hand, the camera 14 having a high resolution has a narrower field of view, which makes it difficult to measure the displacement (translation displacement and rotation displacement) of the measurement object W during image capturing by the first image capturing system 10.

Since the second image capturing system 50 measures the displacement (translation displacement and rotation displacement) of the measurement object W during image capturing by the first image capturing system 10, the cameras 51 and 52 do not need a resolution high enough to distinguish the space that is the resolution required for the camera 14. Since the cameras 51 and 52 do not need a high resolution, the field of view of the cameras 51 and 52 is wide, which makes it possible to detect the displacement of the measurement object W during image capturing by the first image capturing system 10.

Therefore, the first image capturing system 10 and the second image capturing system 50 use the cameras having different characteristics depending on their purposes.

### Control Device

The control device 90 includes an arithmetic circuit including with various kinds of processors, memories, and the like. The various kinds of processors include a central processing unit (CPU), a graphics processing unit (GPU), an application specific integrated circuit (ASIC), a programmable logic device (for example, a simple programmable logic device (SPLD), a complex programmable logic device (CPLD), and field programmable gate arrays (FPGA)), and the like. Various kinds of functions of the control device 90 may be implemented by one processor or may be implemented by a plurality of processors of the same type or different types.

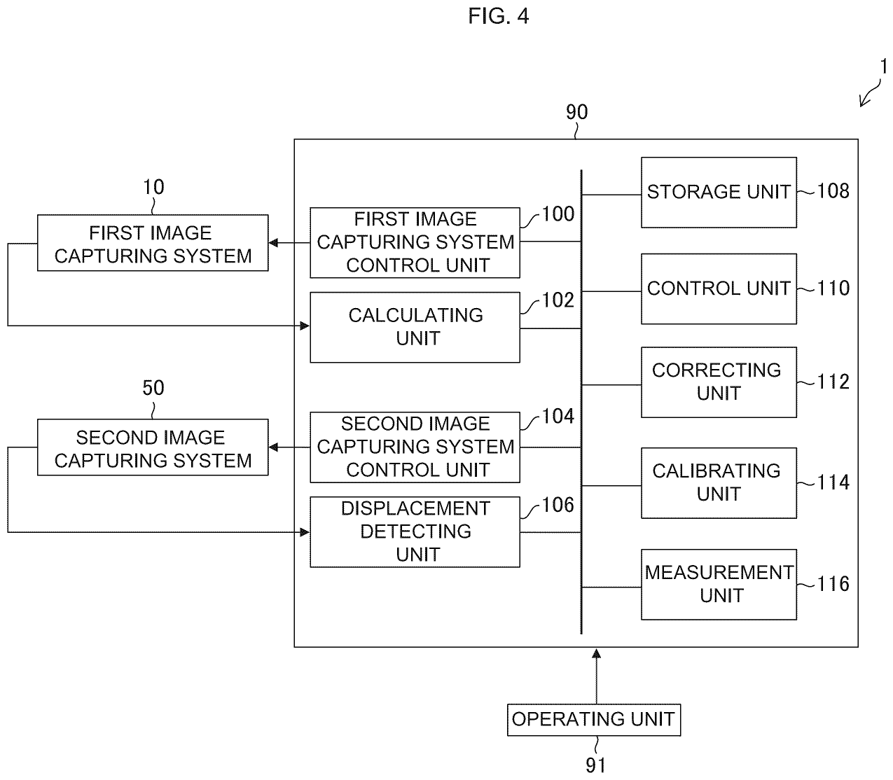

FIG. 4 is a functional block diagram of the control device 90 for the surface shape measurement device 1 of the first embodiment. As indicated in FIG. 4, the control device 90 is connected to the first image capturing system 10, the second image capturing system 50 and the operating unit 91.

The control device 90 includes a first image capturing system control unit 100, a calculating unit 102, a second image capturing system control unit 104, a displacement detecting unit 106, the storage unit 108, a control unit 110, a correcting unit 112, a calibrating unit 114, and a measurement unit 116, and when the control device 90 executes an unillustrated control program read from the storage unit 108, the respective functions are implemented, and their processing is executed. The control unit 110 controls the entire processing of the control device 90. Further, the storage unit 108 stores various kinds of programs, measurement results and the like, and also stores coordinate system transformation information described later. The coordinate system transformation information is a coordinate system transformation matrix that transforms the second coordinate system to the first coordinate system. The coordinate system transformation information is not particularly limited as long as coordinate system transformation from the second coordinate system to the first coordinate system is possible, and information in a format other than the matrix may also be used. For example, the coordinate system transformation information may be a mathematical expression or a parameter description.

The first image capturing system control unit 100 controls the camera 14, the driving unit 16, the light source unit 26, and the stage driving unit 74 of the first image capturing system 10 to acquire the first captured images of the measurement object W. Specifically, the first image capturing system control unit 100 controls the driving unit 16 to cause the optical head 12 to scan in the Z direction after emission of the measurement light L1 from the light source unit 26 is started. Further, the first image capturing system control unit 100 causes the camera 14 to capture images of the measurement object W at a prescribed imaging interval and to repeatedly execute output of the first captured images to the control device 90, based on a detection result of the position of the optical head 12 in the Z direction by the encoder 18 while the driving unit 16 causes the optical head 12 to scan in the Z direction.

The calculating unit 102 detects luminance values for each pixel of the first captured images in which interference fringes are generated. Further, the calculating unit 102 compares envelopes of luminance values (inference signals) based on the luminance values for each pixel on the same coordinate of the respective first captured images (imaging elements of the camera 14). The calculating unit 102 calculates the surface shape (three-dimensional shape) of the measurement object W by calculating height information of the measurement object W for each pixel on the same coordinate by determining the position in the Z direction at which the envelopes for each pixel on the same coordinate of the first captured images become maximum.

The second image capturing system control unit 104 controls the cameras 51 and 52 of the second image capturing system 50 to capture images of the measurement object W in synchronization with the first image capturing system 10, and outputs the stereo images SG to the control device 90 as the second captured images.

The displacement detecting unit 106 obtains coordinates before displacement (initial position) and coordinates after displacement (current position) of points of interest that are set on the measurement object W based on the second captured images of the second image capturing system 50, and calculates (detects) a displacement matrix indicating displacement (translation displacement and rotation displacement) of the current position relative to the initial position.

Here, as a form for setting a point of interest that is set on the measurement object W, there are (A) form without a marker attached to the measurement object W and (B) form with a marker attached to the measurement object W. The respective forms are described below.

### (A) Form Without Marker Attached to Measurement Object W

When the first image capturing system 10 captures images of the measurement object W and the measurement object W has a feature point that can be tracked with sufficient accuracy, the feature point is set as the point of interest.

In the form without a marker attached to the measurement object W, the displacement of the measurement object W can be detected from the second captured images captured by the second image capturing system 50 using an optical flow method.

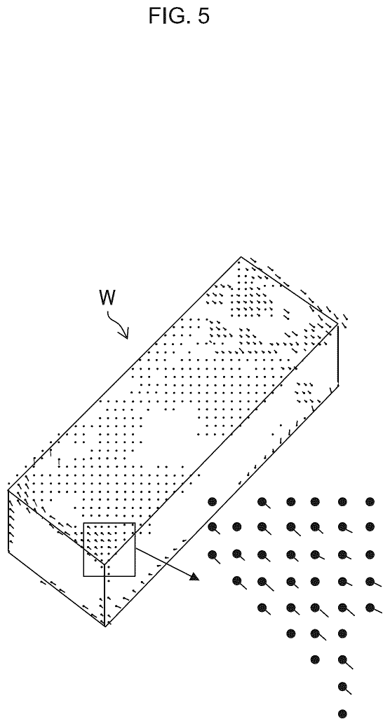

FIG. 5 is an explanatory view for describing the optical flow. As indicated in FIG. 5, the optical flow is a displacement vector for each feature point on the measurement object W. In the optical flow method, two-dimensional vector fields representing displacement vectors can be obtained based on the assumption that the luminance of an object on the screen does not change over consecutive image capturing frames and that the surfaces of the measurement object W viewed by adjacent pixels move in the same direction.

If it is difficult to set a feature point on the measurement object W, the feature point may be set on the jig 72 on which the measurement object W is mounted, and the displacement of the jig 72 may be detected by the optical flow method. The displacement of the jig 72 detected in this case can be regarded as an equivalence, or the like, of the displacement of the measurement object W.

(B) Form with Marker Attached to Measurement Object W

When the first image capturing system 10 captures images of the measurement object W and the measurement object W does not have a feature point that can be tracked with sufficient accuracy, a marker is attached to the measurement object W. A relative displacement of the measurement object W can be detected by tracking the marker attached to the measurement object W as a point of interest.

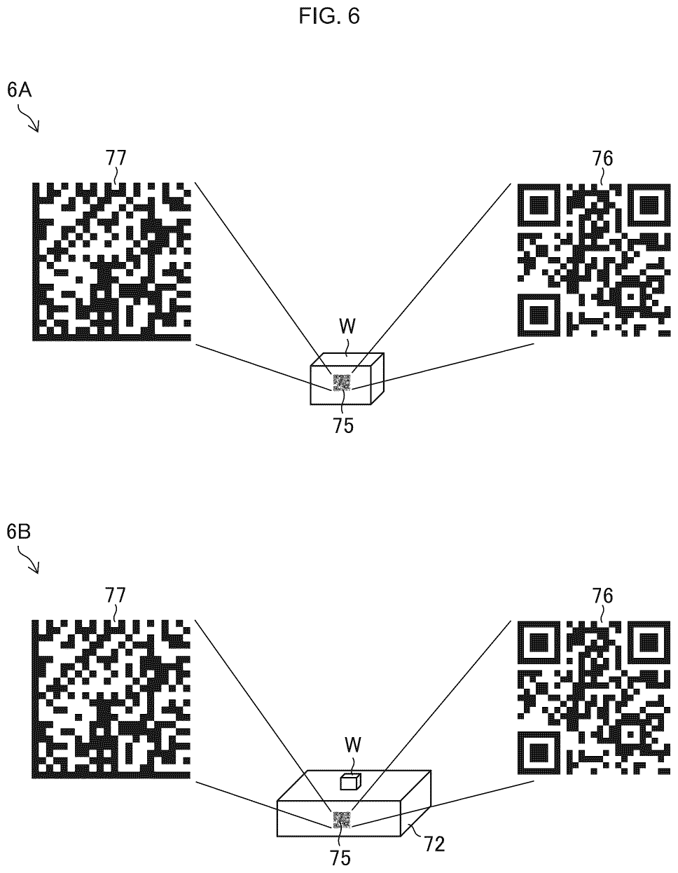

FIG. 6 illustrates an example of the marker. In a portion 6A of FIG. 6, a two-dimensional barcode 75 is attached to the measurement object W as the marker. As the two-dimensional barcode 75, for example, a QR code (registered trademark) 76 indicated on the right side of FIG. 6 can be used. In place of the QR code 76, a data matrix (registered trademark) 77 indicated on the left side of FIG. 6 can also be used.

In a portion 6B of FIG. 6, the two-dimensional barcode 75 is attached to the jig 72 as the marker. When the measurement object W is too small to have a marker attached thereto, the two-dimensional barcode 75 may be attached to the jig 72 to detect the displacement of the jig 72 as the displacement of the measurement object W. In the form with the two-dimensional barcode 75 attached to the jig 72, the QR code 76 or the data matrix 77 can also be used in the same way as the form with the two-dimensional barcode 75 attached to the measurement object W (portion 6A in FIG. 6).

While the two-dimensional barcode 75 has been illustrated as an example of the marker, simple graphics such as circles can be used as the marker. The marker may be the two-dimensional barcode 75 or graphics, as long as the marker that is recognized at the start of the measurement can be tracked.

When one of the above-stated two forms (A) and (B) is selected as the form for setting the point of interest on the measurement object W, the displacement detecting unit 106 calculates a displacement matrix indicating the displacement of the measurement object W during image capturing by the camera 14 of the first image capturing system 10 by obtaining the coordinates before and after the displacement of the point of interest (that is, the initial position and the current position of the point of interest) that is set by a stereo camera scheme, based on the result of image capturing by the second image capturing system 50. Here, since the displacement matrix is calculated based on the result of image capturing by the second image capturing system 50 and is determined based on the second coordinate system, the displacement matrix is hereinafter referred to as the “second coordinate system displacement matrix”.

Here, description is given of a method for deriving the second coordinate system displacement matrix obtained in the displacement detecting unit 106.

Assuming that Pᵢ(0) represents a pre-displacement coordinate (initial position) of each point of interest on the measurement object W in a zeroth frame, which is obtained by using the cameras 51 and 52 of the second image capturing system 50 and Pᵢ(n) represents a post-displacement coordinate (current position) measured in an n-th frame, Pᵢ(0) can be expressed by a following expression (1) and Pᵢ(n) can be expressed by a following expression (2) based on the second captured images obtained by image capturing. A subscript “i” indicates a position number of the point of interest, and “n” in parentheses indicates the order of the pertinent frame.

$$\begin{matrix}{P}_{i} ( 0 ) = {[ {X}_{i} ( 0 ) , {Y}_{i} ( 0 ) , {Z}_{i} ( 0 ) , 1 ]}^{T} & ( 1 ) \\ {P}_{i} ( n ) = {[ {X}_{i} ( n ) , {Y}_{i} ( n ) , {Z}_{i} ( n ) , 1 ]}^{T} & ( 2 )\end{matrix}$$

Assuming that M_{B}(n) represents a second coordinate system displacement matrix expressing the amount of displacement (translation displacement and rotation displacement) of the measurement object W from the zeroth frame to the n-th frame, Pᵢ(0) and Pᵢ(n) can be expressed by a following expression (3).

$${P}_{i} ( n ) = {M}_{B} ( n ) {P}_{i} ( 0 ) \qquad ( 3 )$$

Therefore, a following expression (4) holds by examining changes in Pᵢ(0) and Pᵢ(n) as the pre-displacement and post-displacement coordinates of four or more points of interest.

$$[ {P}_{0} ( n ) , {P}_{1} ( n ) , … , {P}_{M} ( n ) ] = {M}_{B} ( n ) [ {P}_{0} ( 0 ) , {P}_{1} ( 0 ) , … , {P}_{m} ( 0 ) ] \qquad ( 4 )$$

Then, when the expression (4) is solved for M_{B}(n), the second coordinate system displacement matrix M_{B}(n), which expresses the amount of displacement (translation displacement and rotation displacement) of the measurement object W, can be obtained.

The displacement detecting unit 106 uses a derivation method as described above to obtain the pre-displacement and post-displacement coordinates (initial position and current position) of four or more points of interest which are obtained using the cameras 51 and 52 of the second image capturing system 50 and which are set on the measurement object W, and calculates (detects), based on the obtained result, the second coordinate system displacement matrix M_{B}(n) that expresses the amount of displacement (translation displacement and rotation displacement) of the measurement object W. The second coordinate system displacement matrix M_{B}(n) calculated in the displacement detecting unit 106 is based on the second coordinate system of the second image capturing system 50.

The correcting unit 112 uses the second coordinate system displacement matrix M_{B}(n) calculated by the displacement detecting unit 106 to correct the surface shape of the measurement object W calculated by the calculating unit 102.

The correcting unit 112 acquires a coordinate system transformation matrix M_{ct} (coordinate system transformation information) stored in the storage unit 108. The coordinate system transformation matrix M_{ct} is a matrix for transforming the second coordinate system of the second image capturing system 50 to the first coordinate system of the first image capturing system 10. Here, the coordinate system transformation matrix M_{ct} is acquired by calibration as advance preparation and is already stored in the storage unit 108 at the time of measuring the measurement object W. The coordinate system transformation matrix M_{ct} is further described later.

Assuming that Pᵢ is a corrected coordinate group, the correcting unit 112 uses a coordinate group Pᵢ(n) of the surface of the measurement object W, the second coordinate system displacement matrix M_{B}(n) detected by the displacement detecting unit 106 and the coordinate system transformation matrix M_{ct} to calculate the corrected coordinate group Pᵢ by a following expression (5). Here, the coordinate group Pᵢ(n) is a coordinate group of the surface of the measurement object W calculated by the calculating unit 102 using the captured images of the N-th frame captured by the first image capturing system 10.

$${P}_{i} = {M}_{ct} {M}_{B} ( n ) {P}_{i} ( n ) \qquad ( 5 )$$

The corrected coordinate group Pᵢ calculated in this way by the correcting unit 112 is obtained by correcting an error caused by the displacement (translation displacement and rotation displacement) that is generated in the measurement object W during image capturing by the first image capturing system 10.

### Surface Shape Measurement Method

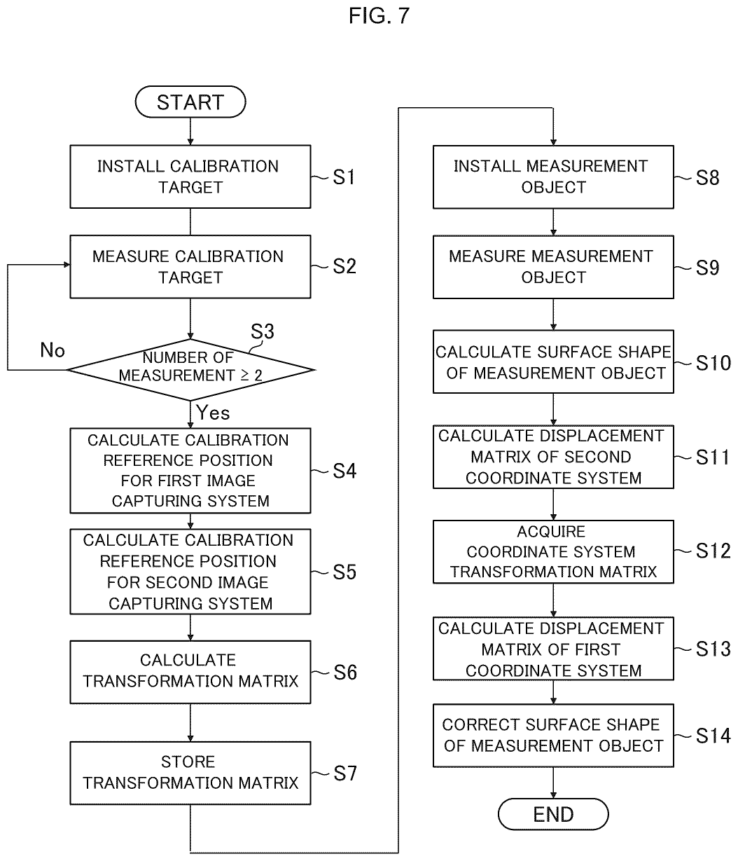

Description is now given of a surface shape measurement method performed by using the surface shape measurement device 1 configured as described above. FIG. 7 is a flowchart indicating an example of the surface shape measurement method. The surface shape measurement method indicated in FIG. 7 may be divided into an advance preparation process (steps S1 to S7) and a measurement process (steps S8 to S14). The respective processes are described below.

### Advance Preparation Process

In the surface shape measurement method in the present embodiment, the advance preparation process is performed before the measurement process is performed. In the advance preparation process, calibrating operation is performed to acquire coordinate system transformation information (coordinate system transformation matrix M_{ct}) for transforming the second coordinate system of the second image capturing system 50 to the first coordinate system of the first image capturing system 10.

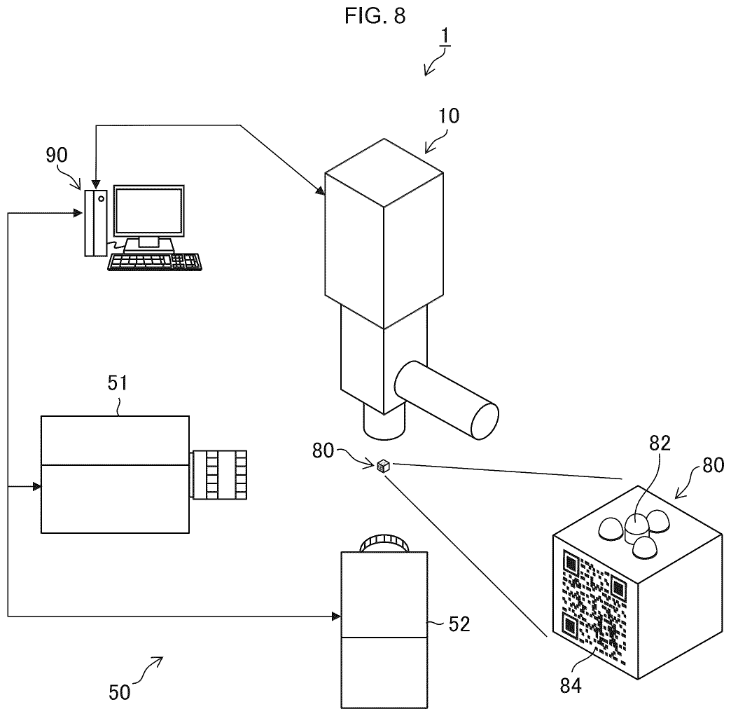

FIG. 8 is an explanatory view for describing the calibrating operation performed in the advance preparation process. As indicated in FIG. 8, in a case of performing the calibrating operation, a calibration target 80 is installed instead of the measurement object W (step S1: process of installing a calibration target). The calibration target 80 in this example has four hemispheres 82 provided on a surface facing upward in the Z direction (surface to be measured facing the first image capturing system 10) and a QR code 84 attached on a side surface (surface facing the second image capturing system 50). The four hemispheres 82 are for calibration of the first image capturing system 10, and the QR code 84 is for calibration of the second image capturing system 50.

Next, measurement is performed on the calibration target 80 in the same way as the measurement of the measurement object W (step S2: process of measuring the calibration target). Specifically, the calibrating unit 114 controls the first image capturing system control unit 100 to cause the first image capturing system 10 to capture images of the calibration target 80 at each prescribed imaging interval while causing the first image capturing system 10 to scan in the vertical direction relative to the calibration target 80, and also controls the second image capturing system control unit 104 to cause the second image capturing system 50 to capture images of the calibration target 80 in synchronization with the first image capturing system 10.

The calibrating unit 114 then determines whether or not this is a second measurement on the calibration target 80 (step 3: process of determining calibration target). If this is the first measurement on the calibration target 80 (No in step S3), processing from steps S2 to S3 is repeated. On the contrary, if this is the second measurement on the calibration target 80 (Yes in step S3), processing proceeds to next step S4. In this example, the measurement on the calibration target 80 is repeated twice, though the measurement may be repeated three times or more. A user can set the number of measurements in the process of determining the calibration target to any number (two or more).

While step S2 is being carried out (that is, while the measurement is performed on the calibration target 80), both the translation displacement and rotation displacement are generated in the calibration target 80.

The calibrating unit 114 then controls the calculating unit 102 to calculate and store four calibration reference positions (three-dimensional coordinates) that are set for the calibration target 80 in advance, based on the image capturing result of the first image capturing system 10 (step S4: process of calculating calibration reference positions for first image capturing system). In this example, the four hemispheres 82 are formed for the calibration target 80 as described above, and the calibrating unit 114 obtains center coordinate positions of the respective four hemispheres 82 as four calibration reference positions ci (n) for each number of the measurements. A subscript “i” in “cᵢ(n)” indicates a calibration reference position number (1 to 4), and “n” in parentheses indicates the number of measurements (1 to 2).

Here, assuming that cᵢ(0) represents the three-dimensional coordinate of each calibration reference position obtained in the first measurement and cᵢ(1) represents the three-dimensional coordinate of each calibration reference position obtained in the second measurement, a following expression (6) holds.

$$[ {c}_{0} ( 1 ) , {c}_{1} ( 1 ) , {c}_{2} ( 1 ) , {c}_{3} ( 1 ) ] = {M}_{A} [ {c}_{0} ( 0 ) , {c}_{1} ( 0 ) , {c}_{2} ( 0 ) , {c}_{3} ( 0 ) ] \qquad ( 6 )$$

M_{A} is a displacement matrix (hereinafter referred to as “first coordinate system displacement matrix”) expressing the displacement (translation displacement and rotation displacement) in the first coordinate system that is inherent to the first image capturing system 10. In other words, the first coordinate system displacement matrix M_{A} is a matrix indicating the correlation between coordinate values of the first image capturing system 10 obtained in the first measurement and coordinate values of the first image capturing system 10 obtained in the second measurement when the calibration target 80 is displaced between the first measurement and the second measurement.

The calibrating unit 114 solves the expression (6), which is defined by the three-dimensional coordinates of the respective calibration reference positions obtained in the first and second measurements as described above, for M_{A}, and thereby obtains M_{A} as the first coordinate system displacement matrix that expresses the displacement (translation displacement and rotation displacement) in the first coordinate system.

The calibrating unit 114 then controls the displacement detecting unit 106 to calculate and store the calibration reference positions (three-dimensional coordinates) that are set for the calibration target 80 in advance, based on the image capturing result of the second image capturing system 50 (step S5: process of calculating calibration reference positions for second image capturing system).

In this example, the QR code 84 is formed on a side surface of the calibration target 80 as described above, and the calibrating unit 114 obtains four calibration reference positions dᵢ(n) defined by the QR code 84 as the calibration reference positions for each number of measurements. A subscript “i” in “dᵢ(n)” indicates a calibration reference position number (1 to 4), and “n” in parentheses indicates the number of measurements (1 to 2).

Here, assuming that the three-dimensional coordinate of each calibration reference position obtained in the first measurement is dᵢ(0), and the three-dimensional coordinate of each calibration reference position obtained in the second measurement is dᵢ(1), a following expression (7) holds.

$$[ {d}_{0} ( 1 ) , {d}_{1} ( 1 ) , {d}_{2} ( 1 ) , {d}_{3} ( 1 ) ] = {M}_{B} [ {d}_{0} ( 0 ) , {d}_{1} ( 0 ) , {d}_{2} ( 0 ) , {d}_{3} ( 0 ) ] \qquad ( 7 )$$

M_{B} is a second coordinate system displacement matrix representing the displacement (translation displacement and rotation displacement) in the second coordinate system that is inherent to the second image capturing system 50. In other words, the second coordinate system displacement matrix M_{B} is a matrix indicating the correlation between coordinate values of the second image capturing system 50 obtained in the first measurement and coordinate values of the second image capturing system 50 obtained in the second measurement when the calibration target 80 is displaced between the first measurement and the second measurement.

The calibrating unit 114 solves the expression (7), which is defined by the three-dimensional coordinates of the respective calibration reference positions obtained in the first and second measurements as described above, for M_{B}, and thereby obtains the M_{B} as the second coordinate system displacement matrix that expresses the displacement (translation displacement and rotation displacement) in the second image capturing system 50.

Since the first coordinate system displacement matrix M_{A} and the second coordinate system displacement matrix M_{B} obtained in this way are the displacement matrices of the same calibration target 80 viewed in different coordinate systems, a following expression (8) holds.

$${M}_{A} = {M}_{ct} {M}_{B} \qquad ( 8 )$$

Here, M_{ct} is a transformation matrix for transforming the second coordinate system of the second image capturing system 50 to the first coordinate system of the first image capturing system 10. In other words, using the coordinate system transformation matrix M_{ct} makes it possible to transform the displacement (translation displacement and rotation displacement) of the measurement object W obtained in the second image capturing system from the second coordinate system to the first coordinate system as described later (see expression (9)).

The calibrating unit 114 obtains the coordinate system transformation matrix M_{ct} from the expression (8) and stores the result in the storage unit 108 (step S6: process of calculating transformation matrix, step S7: process of storing transformation matrix).

The advance preparation process is completed as described above. In a case where the calibrating unit 114 has already obtained the coordinate system transformation matrix M_{ct} and stored the result in the storage unit 108, the advance preparation process is not necessarily required. Specifically, in a case where the relative positions of the first image capturing system 10 and the second image capturing system 50 have not changed since the last calibrating operation (for example, in a case where the measuring process described later is continuously performed), the coordinate system transformation matrix M_{ct} is maintained constant, and therefore the calibrating operation described above can be omitted and it is not necessary to perform calibrating operation every time the measurement is performed.

### Measurement Process

As indicated in FIG. 1, the measurement object W is installed at a measurement position of the surface shape measurement device 1 (step S8: process of installing measurement object). The measurement object W may be in the form without a marker attached to the measurement object W or the form with a marker attached thereto. The measurement object W may be mounted or not mounted on the jig 72.

Next, measurement is performed on the installed measurement object W (step S9: process of measuring measurement object). Specifically, the measurement unit 116 controls the first image capturing system control unit 100 to cause the first image capturing system 10 to capture images of the measurement object W at each prescribed imaging interval while causing the first image capturing system 10 to scan in the vertical direction relative to the measurement object W, and also controls the second image capturing system control unit 104 to cause the second image capturing system 50 to capture images of the measurement object W in synchronization with the first image capturing system 10.

Next, the calculating unit 102 calculates the surface shape of the measurement object W (step S10: process of calculating surface shape). Specifically, the calculating unit 102 measures the three-dimensional shape (surface shape) of the surface to be measured of the measurement object W from the result of image capturing by the first image capturing system 10 and calculates a coordinate group Pᵢ(n) of the surface of the measurement object W.

Next, the displacement detecting unit 106 calculates the second coordinate system displacement matrix M_{B}(n) from the result of image capturing by the second image capturing system 50 (step S11: process of calculating second coordinate system displacement matrix). Specifically, the displacement detecting unit 106 calculates the second coordinate system displacement matrix M_{B}(n) based on the expressions (1) to (4).

The correcting unit 112 then acquires the coordinate system transformation matrix M_{ct} from the storage unit 108 (step S12: process of acquiring coordinate system transformation matrix). The coordinate system transformation matrix M_{ct} is acquired in the advance preparation process and is stored in the storage unit 108.

Next, the correcting unit 112 calculates the first coordinate system displacement matrix M_{A}(n) from the coordinate system transformation matrix M_{ct} and the second coordinate system displacement matrix M_{B}(n) (step S13: process of calculating first coordinate system displacement matrix). Specifically, the correcting unit 112 calculates the first coordinate system displacement matrix M_{A}(n) from a following expression (9).

$${M}_{A} = {M}_{ct} {M}_{B} \qquad ( 9 )$$

Next, the correcting unit 112 corrects the surface shape of the measurement object using the first coordinate system displacement matrix M_{A}(n) (step S14: correcting process). Specifically, the correcting unit 112 calculates a corrected coordinate group Pᵢ from the coordinate group Pᵢ(n) and the first coordinate system displacement matrix M_{A}(n) using a following expression (10). The processing is finished when the corrected coordinate group Pᵢ can be calculated.

$${P}_{i} = {M}_{A} ( n ) {P}_{i} ( n ) \qquad ( 10 )$$

In the present embodiment, the surface shape of the measurement object W calculated from the first captured images captured by the first image capturing system 10 is corrected from the displacement of the measurement object W detected based on the second captured images captured by the second image capturing system 50 that is separate from the first image capturing system 10 and on the coordinate system transformation information for transforming the second coordinate system of the second image capturing system 50 to the first coordinate system of the first image capturing system 10, so that the surface shape can be measured with high accuracy.

### Second Embodiment

A second embodiment is described with reference to the drawings. Portions demonstrating identical effects to those in the first embodiment described above are denoted by identical reference numerals to omit detailed description thereof, and description is mainly given of the points different from other embodiment.

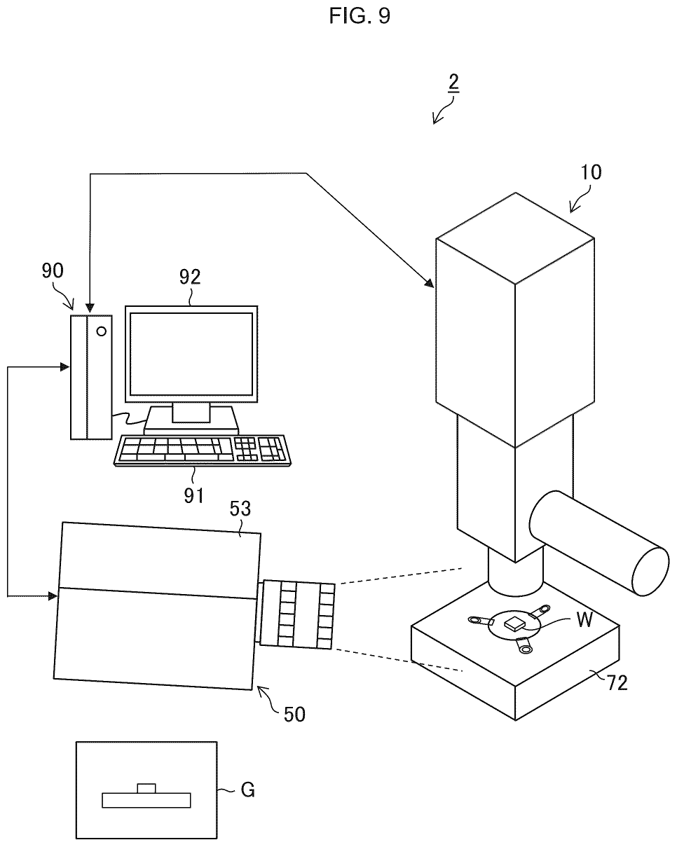

FIG. 9 is a schematic view of a surface shape measurement device 2 that measures the surface shape of the measurement object W. Here, the surface shape measurement device 2 of the second embodiment is different in the configuration of the second image capturing system 50 from the surface shape measurement device 1 of the first embodiment. The second image capturing system 50 of the second embodiment includes a single camera 53 (monocular camera), which captures a single image G as a second captured image according to an image capturing instruction and outputs the image G to the control device 90. The second embodiment is particularly useful in cases where only a configuration with one camera can be selected depending on the limitations in installation space. Further, the first embodiment is different in processing of the displacement detecting unit 106 from the second embodiment.

The first image capturing system 10 and the calculating unit 102 in the second embodiment are similar to those of the first embodiment. In the second embodiment, as in the first embodiment, the form with a marker attached to the measurement object W and the form without a marker attached to the measurement object W can be selected as the form for setting the point of interest on the measurement object W.

In the second embodiment, the displacement detecting unit 106 detects, for example, the displacement (translation displacement and rotation displacement) in a following procedure.

Assuming that pᵢ(0) represents a pre-displacement coordinate (initial position) of each point of interest on the measurement object W in a zeroth frame, which is obtained by using the camera 53 of the second image capturing system 50 and pᵢ(n) represents a post-displacement coordinate (current position) measured in an n-th frame, pᵢ(0) can be expressed by a following expression (11) and pᵢ(n) can be expressed by a following expression (12) based on the second captured image obtained by the camera 53 of the second image capturing system 50. A subscript “i” indicates a position number of the point of interest, and “n” in parentheses indicates the order of the pertinent frame.

$${p}_{i} ( 0 ) = {[ {x}_{i} ( 0 ) , {y}_{i} ( 0 ) , 1 ]}^{T} \qquad ( 11 )$$

$${p}_{i} ( n ) = {[ {x}_{i} ( n ) , {y}_{i} ( n ) , 1 ]}^{T} \qquad ( 12 )$$

The pre-displacement coordinate pᵢ(0) and the post-displacement coordinate pᵢ(n) are acquired as two-dimensional coordinates in the image (second captured image) captured by one camera 53. Therefore, unlike the first embodiment, following processing is required.

First, consider a case where a point Pᵢ(n) in three-dimensional space is captured by the camera 53 and is projected onto a point pᵢ(n) on a two-dimensional image. Assuming that A[R(n)|t(n)] represents a matrix for projecting Pᵢ(n) in the three-dimensional space onto the two-dimensional point pᵢ(n), a following expression (13) holds for Pᵢ(n) and pᵢ(n).

$${p}_{i} ( n ) = A [ R ( n ) \vert t ( n ) ] {P}_{i} ( n ) \qquad ( 13 )$$

Here, “A” is referred to as an internal parameter or a camera matrix, which is a unique 3×3 matrix depending on the focal length of a lens or the number of pixels of an imaging element. R(n) is a 3×3 matrix expressing rotation displacement, and t(n) is a 3×1 vector expressing translation displacement. Here, [R(n)|t(n)] is a 3×4 rotation translation matrix expressing the rotation displacement and the translation displacement in three-dimensional space.

The camera matrix A is generally indicated by a following expression (14) to express mapping from three-dimensional space to a two-dimensional plane.

$$\begin{matrix}[ Formula 1 ] & \\ [ \begin{matrix}{f}_{x} & 0 & {c}_{x} \\ 0 & {f}_{y} & {c}_{y} \\ 0 & 0 & 1\end{matrix} ] & ( 14 )\end{matrix}$$

If R(n) is expressed using θ or the like, R(n) is generalized to be a product of rotation matrices around respective axes, as in expression (15) below.

$$R ( n ) = {R}_{x} ( α ) {R}_{y} ( β ) {R}_{z} ( γ ) \qquad ( 15 )$$

If θ represents respective angles of Rₓ(α), R_{y}(β) and R_{z}(γ), the respective angles can be expressed by a following expression (16).

$$\begin{matrix}[ Formula 2 ] & \\ Rx ( θ ) = ( \begin{matrix}1 & 0 & 0 \\ 0 & cos θ & - sin θ \\ 0 & sin θ & cos θ\end{matrix} ) & ( 16 )\end{matrix}$$

$$Ry ( θ ) = ( \begin{matrix}cos θ & 0 & sin θ \\ 0 & 1 & 0 \\ - sin θ & 0 & cos θ\end{matrix} )$$

$$Rz ( θ ) = ( \begin{matrix}cos θ & - sin θ & 0 \\ sin θ & cos θ & 0 \\ 0 & 0 & 1\end{matrix} )$$

Since t(n) is a 3×1 vector representing the translation displacement, it can be expressed by a following expression (17).

$$t ( n ) = {[ x , y , z ]}^{T} \qquad ( 17 )$$

Thus, the expression (13) is a matrix that maps a point in three-dimensional space to a two-dimensional plane.

Next, the form with a marker attached to the measurement object W and the form without a marker attached to the measurement object W are each described.

First, the form with a marker attached to the measurement object W is described. The camera matrix A can be obtained in advance by a method known as camera calibration. Accordingly, in a case of using a marker, Pᵢ(n) in three-dimensional space and two-dimensional pᵢ(n) are known values. As a result, in expression (13), R(n) and t(n) are unknown, so that a following expression (18) holds.

$${A}^{- 1} [ {p}_{0} ( n ) , {p}_{1} ( n ) , ... , {p}_{I} ( n ) ] = [ R ( n ) \vert t ( n ) ] [ {P}_{0} ( n ) , {P}_{1} ( n ) , ... , {P}_{I} ( n ) ] \qquad ( 18 )$$

Then, by solving the expression (18) for [R(n)|t(n)], the rotation translation matrix [R(n)|t(n)] can be obtained.

Next, the form without a marker attached to the measurement object W is described. In a case of the form without using a marker, Pᵢ(n) is also included in unknown in addition to R(n) and t(n) in expression (13), so that expression (13) cannot be solved directly. As a result, it is not possible to obtain the rotation translation matrix [R(n)|t(n)] directly.

Accordingly, a bundle adjustment scheme is applied to obtain R(n), t(n) and Pᵢ(n) relative to n=0. The bundle adjustment scheme exists as a known technique (“Bundle Adjustment for 3D Reconstruction: Implementation and Evaluation” by Yuuki Iwamoto, Yasuyuki Sugaya, and Kenichi Kanatani, Computer Vision and Image Media (CVIM) 2011.19 (2011): 1-8.).

The rotation translation matrix [R(n)|t(n)] can be obtained in both the form with a marker attached to the measurement object W and the form without a marker attached to the measurement object W. Using the rotation translation matrix [R(n)|t(n)] obtained by the above method, the displacement detecting unit 106 calculates (detects) the second coordinate system displacement matrix M_{B}(n) as the displacement (translation displacement and rotation displacement) of the measurement object W by a following expression (19).

$${M}_{B} ( n ) = {[ R ( n ) \vert t ( n ) ; 0 \vert 1 ]}^{- 1} \qquad ( 19 )$$

As in the first embodiment, the correcting unit 112 uses the second coordinate system displacement matrix M_{B}(n) calculated by the displacement detecting unit 106 and the coordinate system transformation matrix M_{ct} stored in the storage unit 108 to correct the surface shape of the measurement object W calculated by the calculating unit 102. Specifically, the correcting unit 112 calculates the corrected coordinate group Pᵢ for the coordinate group Pᵢ(n) of the surface of the measurement object W by a following expression (20).

$${P}_{i} = {M}_{ct} {M}_{B} ( n ) {P}_{i} ( n ) \qquad ( 20 )$$

In the second embodiment, as well as in the first embodiment, the advance preparation process is also carried out. In the second embodiment, unlike the first embodiment, the surface shape measurement device 2 indicated in FIG. 9 is applied in the advance preparation process.

Even in the second embodiment where the second image capturing system 50 includes a single camera 53, the surface shape of the measurement object W calculated from the first captured images captured by the first image capturing system 10 is corrected from the displacement of the measurement object W detected based on the second captured image captured by the second image capturing system 50 that is separate from the first image capturing system 10 and on the coordinate system transformation information for transforming the second coordinate system of the second image capturing system 50 to the first coordinate system of the first image capturing system 10 as in the first embodiment, so that the surface shape can be measured with high accuracy.

Although the case where the optical head 12 in the first image capturing system 10 is a Michelson-type white interference microscope has been described, the optical head 12 may be a Mirau-type white interference microscope or a Linnik-type white interference microscope. The optical head 12 may also be a microscope employing one of the laser confocal scheme and the focal point scheme.

### REFERENCE SIGNS LIST

1 . . . Surface shape measurement device, 2 . . . Surface shape measurement device, 10 . . . First image capturing system, 12 . . . Optical head, 14 . . . Camera, 16 . . . Driving unit, 18 . . . Encoder, 26 . . . Light source unit, 28 . . . Beam splitter, 30 . . . Interference objective lens, 30A . . . Objective lens, 30B . . . Beam splitter, 30C . . . Reference surface, 32 . . . Imaging lens, 50 Second image capturing system, 51, 52, 53 . . . Camera, 70 . . . Stage, 72 . . . Jig, 74 . . . Stage driving unit, 75 . . . Two-dimensional barcode, 76 . . . QR Code, 77 . . . Data matrix, 80 . . . Calibration target, 82 . . . Hemisphere, 84 . . . QR Code, 90 . . . Control device, 91 . . . Operating unit, 92 . . . Display unit, 100 . . . First image capturing system control unit, 102 . . . Calculating unit, 104 . . . Second image capturing system control unit, 106 . . . Displacement detecting unit, 108 . . . Storage unit, 110 . . . Control unit, 112 . . . Correcting unit, 114 . . . Calibrating unit, 116 . . . Measurement unit, W . . . Measurement object

What is claimed is:

1. A surface shape measurement device configured to measure a surface shape of a measurement object, comprising:
a first image capturing system configured to capture an image of the measurement object at each prescribed imaging interval while scanning in a vertical direction relative to the measurement object;
a second image capturing system including a monocular camera that is separate from the first image capturing system, the monocular camera configured to capture an image of the measurement object or a support body for the measurement object in synchronization with the first image capturing system;
a calculating unit configured to calculate the surface shape of the measurement object based on a plurality of first captured images captured by the first image capturing system;
a storage unit configured to store coordinate system transformation information for transforming a second coordinate system of the second image capturing system to a first coordinate system of the first image capturing system;
a displacement detecting unit configured to detect displacement of the measurement object during image capturing by the first image capturing system by a bundle adjustment scheme based on a plurality of second captured images captured by the monocular camera; and
a correcting unit configured to correct the surface shape calculated by the calculating unit based on a detection result of the displacement detecting unit and on the coordinate system transformation information.

2. The surface shape measurement device according to claim 1, wherein
the coordinate system transformation information is a transformation matrix that transforms the second coordinate system to the first coordinate system.

3. The surface shape measurement device according to claim 1, comprising a calibrating unit configured to acquire the coordinate system transformation information from a result of image capturing on a calibration target by the first image capturing system and the second image capturing system.

4. The surface shape measurement device according to claim 1, wherein
the first image capturing system has higher resolution than the second image capturing system.

5. The surface shape measurement device according to claim 1, wherein
the first image capturing system and the second image capturing system are configured to move independently.

6. The surface shape measurement device according to claim 1, wherein
when a marker is attached to the measurement object or the support body for the measurement object, the displacement detecting unit tracks the marker to detect the displacement of the measurement object.

7. The surface shape measurement device according to claim 1, wherein
when a marker is not attached to the measurement object or the support body for the measurement object, the displacement detecting unit tracks a feature point set for the measurement object or the support body for the measurement object to detect the displacement of the measurement object.

8. The surface shape measurement device according to claim 1, wherein
the first image capturing system is a microscope employing any one of a white interference scheme, a laser confocal scheme, and a focal point scheme.

9. A surface shape measurement method, comprising:
a first image capturing step of capturing an image of a measurement object at each prescribed imaging interval while causing a first image capturing system to scan in a vertical direction relative to the measurement object;
a second image capturing step of using a second image capturing system including a monocular camera that is separate from the first image capturing system to capture an image of the measurement object or a support body for the measurement object in synchronization with the first image capturing system;
a calculating step of calculating a surface shape of the measurement object based on a plurality of first captured images captured in the first image capturing step;
a displacement detecting step of detecting displacement of the measurement object during image capturing by the first image capturing system by a bundle adjustment scheme based on a plurality of second captured images captured by the monocular camera; and
a correcting step of correcting the surface shape calculated in the calculating step based on a detection result of the displacement detecting step and on coordinate system transformation information for transforming a second coordinate system of the second image capturing system to a first coordinate system of the first image capturing system.
